(19) United States
(12) Patent Application Publication
(10) Pub. No.: US 2024/0350968 A1
(43) Pub. Date: Oct. 24, 2024

(54) CARBON CAPTURE SYSTEM FOR FLARE OR COMBUSTION GAS

(71) Applicant: HYDROZONIX, LLC, CONROE, TX (US)

(72) Inventor: MARK PATTON, CONROE, TX (US)

(21) Appl. No.: 18/642,154

(22) Filed: Apr. 22, 2024

Related U.S. Application Data
(60) Provisional application No. 63/461,262, filed on Apr. 22, 2023.

(51) Int. Cl. B01D 53/18; B01D 53/14

(52) U.S. Cl. CPC B01D 53/18; B01D 53/1418; B01D 53/1425; B01D 53/1475; B01D 2257/504

(57) ABSTRACT

A system and apparatus for treating and disposing of produced water in conjunction with flared gas, thereby avoiding problems associated with injecting produced water back into subsurface strata. The system is installed at or near the wellhead where produced water being treated is at a higher temperatures. Produced water is treated with ozone injection in a scrubber with heat applied through a flare gas field burner, which uses field gas from oilfield operations. A wet scrubber unit with scrubber packing is used to clean emissions. An amine solution is injected through spray nozzles in the scrubber unit for use as the wet scrubbing agent to absorb carbon dioxide. Amine solution with carbon dioxide is removed to an amine tank, and heated tor remove the carbon dioxide is gaseous form.

This application claims benefit of and priority to U.S. Provisional App. No. 63/461,262, filed Apr. 22, 2023, which is incorporated herein in its entirety by specific reference for all purposes.

### BACKGROUND OF INVENTION

Variations of a water evaporator system that additionally reduces emissions from flaring and/or combustion of field gas, or from turbine exhaust gas, are described in U.S. patent application Ser. No. 17/533,840, filed Nov. 23, 2021; U.S. patent application Ser. No. 16/653,864, filed Oct. 15, 2019; and U.S. patent application Ser. No. 15/711,896, filed Sep. 21, 2017; all of which are incorporated herein in their entireties by specific reference for all purposes.

### FIELD OF INVENTION

This invention relates to a system and apparatus for flaring gas from oilfield operations using produced water with carbon capture.

### SUMMARY OF INVENTION

In various exemplary embodiments, the present invention comprises a system and apparatus for carbon capture for flare gas systems flaring gas from oilfield operations using produced water. The basic flare gas system provides an alternative treatment and disposal technique for produced water, thereby avoiding problems associated with injecting produced water back into subsurface strata, such as induced seismicity. The system is configured to be installed at or near the wellhead, thereby avoiding the problems of prior art centralized systems for handling produced water, which are substantially larger and built at a central location to store and gather large quantities of produced water. Centralized systems require the produced water to travel much greater distances and become cooler before treatment, thereby requiring more energy for heating or treatment. In several embodiments, the present invention uses produced water that is at a temperature of greater than 100 degrees F., thereby reducing the amount of energy required for heating.

In one exemplary embodiment, produced water is treated in a scrubber. Heat is applied through a flare gas field burner, which uses field gas from the oilfield operations (and thus provides a useful alternative to simply open flaring the field gas as a means of preventing the accumulation of field gas for safety reasons as well as preventing the venting of methane, a greenhouse gas, into the atmosphere). A wet scrubber unit with scrubber packing is used to clean emissions (e.g., nitrous oxides, sulfur oxides, acid gases, particulate matter, and the like). A produced water pump is used to circulate produced water, and pump produced water through spray nozzles in the scrubber unit for use as the wet scrubbing agent. The present invention thus optimizes contact and mixing between the hot air and water.

The above process also results in gradual evaporation of the produced water, which results in the accumulation of salts and other solids from the produced water. Evaporated salts and solids are continuously removed from the evaporator/scrubber unit by appropriate means, such as an auger system. The evaporated salts and solids are then treated via chemical stabilization in a mixing system with chemical reagents to prevent the residual form from being hazardous. The residual material is then stored and disposed of properly.

For carbon-capture, the fluids in the wet scrubber/evaporation tower are replaced by an amine solution, which provides CO₂ absorption. The amine solution is then removed and heated to recover and collect the CO₂.

The present invention thus provides a more environmentally-friendly and efficient means of addressing several pollution and related concerns. First, the system eliminates open flaring by using the field gas in a field gas flare burner to heat produced water, and scrubbing the emissions using the heated produced water in a scrubbing unit. Second, the system eliminates or reduces the volume of produced water. Third, the system operates at or near the wellhead, thereby allowing use of the field gas while treating the produced water with less energy required. And fourth, carbon is captured for subsequent storage and/or sequestration.

### BRIEF DESCRIPTION OF THE DRAWINGS

FIG. 1 shows a view of a basic flare gas treatment system in accordance with an embodiment of the present invention.

FIG. 2 shows a diagram of a flare gas treatment with a carbon capture and sequestration system.

FIGS. 3-5 show examples of ozone injection in combination with carbon capture systems.

### DETAILED DESCRIPTION OF EXEMPLARY EMBODIMENTS

In various exemplary embodiments, the present invention comprises a system and apparatus for flaring gas from oilfield operations using produced water. The system provides an alternative treatment and disposal technique for produced water, thereby avoiding problems associated with injecting produced water back into subsurface strata, such as induced seismicity.

The improved system of the present invention also is configured to be installed at or near (i.e., close proximity to) the wellhead, thereby avoiding the problems of prior art centralized systems for handling produced water, which are substantially larger and built at a central location to store and gather large quantities of produced water. Centralized systems, however, require the produced water to travel much greater distances and become cooler before treatment, thereby requiring more energy for heating or treatment. The present invention uses produced water that is at a temperature of greater than 100 degrees F., thereby reducing the amount of energy required for heating.

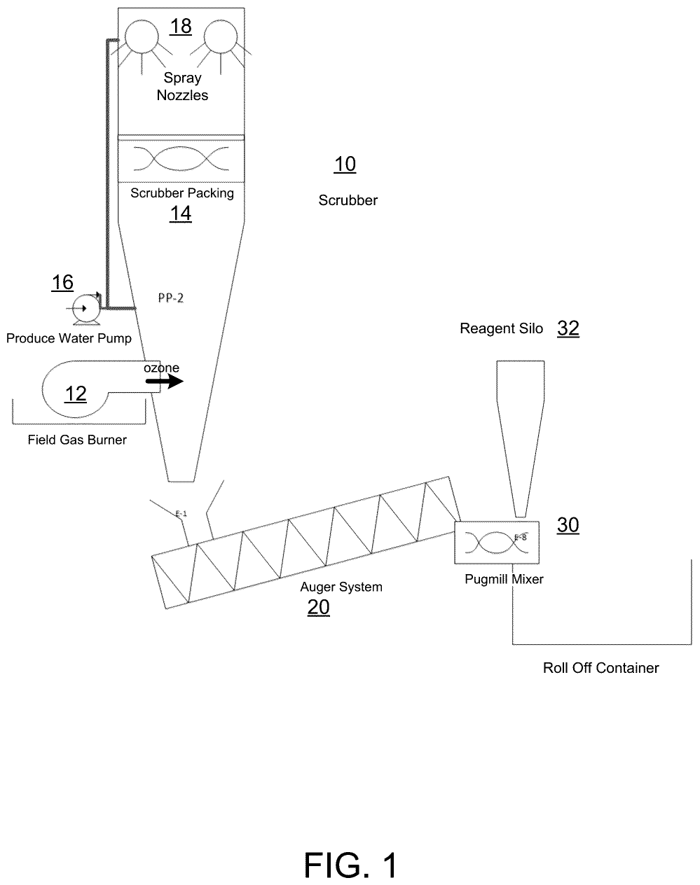

FIG. 1 shows an exemplary embodiment of a flare gas system in accordance with the present invention. Produced water is treated in the scrubber 10. Heat is applied through a flare gas field burner 12, which uses field gas from the oilfield operations (and thus provides a useful alternative to simply open flaring the field gas as a means of preventing the accumulation of field gas for safety reasons as well as preventing the venting of methane, a greenhouse gas, into the atmosphere). A wet scrubber unit with scrubber packing 14 is used to clean emissions (e.g., nitrous oxides, sulfur oxides, acid gases, particulate matter, and the like). A produced water pump 16 is used to circulate produced water, and pump produced water through spray nozzles 18 in the scrubber unit for use as the wet scrubbing agent. The present invention thus optimizes contact and mixing between the hot air and water.

In an alternative embodiment, ozone is used in the wet scrubber 10 to reduce NOx by approximately 90% or more. The ozone oxidizes insoluble NOx to a water soluble species form for removal by the scubber with little or no SO2 or CO oxidation. In several exemplary embodiments, the oxidation of NOx takes place at or below 300 degrees F. (i.e., low temperature oxidation). Ozone may be generated on-site and injected to the evaporator/scrubber unit. In several embodiments, the ozone is added to the effluent gas of the thermal oxidizer prior to entering the evaporation chamber. As a result, NOx emissions are reduced.

The above process also results in gradual evaporation of the produced water, which results in the accumulation of salts and other solids from the produced water. Evaporated salts and solids are continuously removed from the evaporator/scrubber unit by appropriate means, such as an auger system 20. The evaporated salts and solids are then treated via chemical stabilization in a mixing system (e.g., treatment mixer) 30 with chemical reagents (which are stored in a reagent silo 32) to chemically stabilize the residual and prevent the residual from being hazardous. The residual material is then stored and disposed of properly.

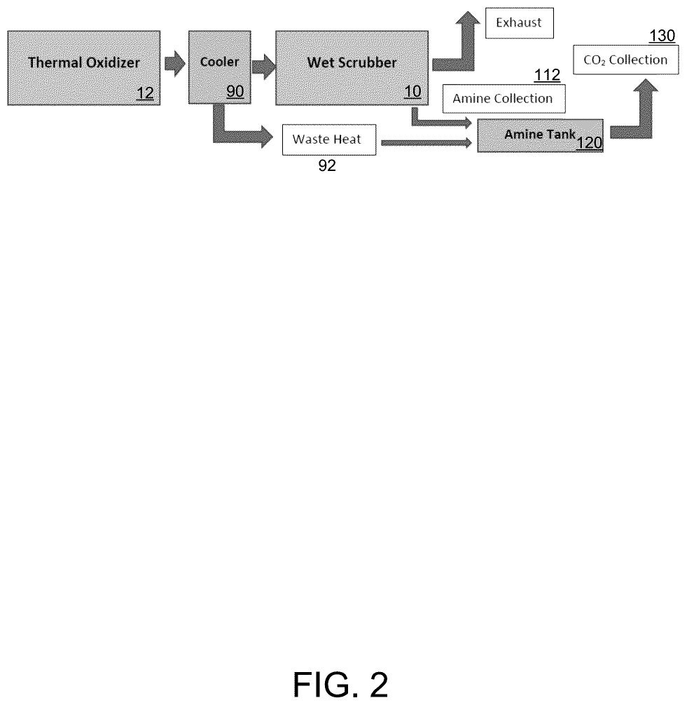

FIG. 2 shows a flare gas system configured for carbon capture. For carbon-capture, the fluids in the wet scrubber/evaporation tower 10 are replaced by an amine solution 110, which provides CO₂ absorption. The CO₂ absorption and collection is with a relatively high purity (greater than 90%). In one embodiment, the amine solution used is monoethanolamine solution (about 20 to 30 wt % in water), but other amine solutions may be used. The amine solution with CO₂ is removed and collected 112 from the scrubber, and heated in an amine tank 120 to approximately 100 to 120° C. or above to recover and collect the CO₂ in gas form 130.

A cooler/heat exchanger or cooling system 90 may be added between the thermal oxidizer/combustor/burner 12 and the scrubber 10 to reduce the temperature of the gas exhaust and promote CO₂ absorption. Alternatively, the solution in the scrubber may be chilled. Waste heat 92 from the cooling system/heat exchangers 90 may be used to heat the amine solution to recover/collect the absorbed CO₂.

The cooling system may include an option to use produced water to provide some cooling, which will allow the evaporation of produced water while also cooling the hot exit gases from the oxidizer (which typically are around 1400° F. Thus, the cooling process may comprise two steps: first, cooling with produced water to evaporate produced water, and second, additional cooling with air, which will provide waste heat for amine solution heating as described above.

As discussed above, ozone may be used in the wet scrubber, which also allows for oxides of nitrogen in gas form to be converted to water-soluble forms due to reaction with the ozone. This reaction allows for greater than 90% reduction of oxides of nitrogen by converting them to nitrates in solution. Oxides of nitrogen have a CO₂e (CO₂ equivalence) of 248x (as they are 248 times stronger greenhouse gases in comparison to CO₂).

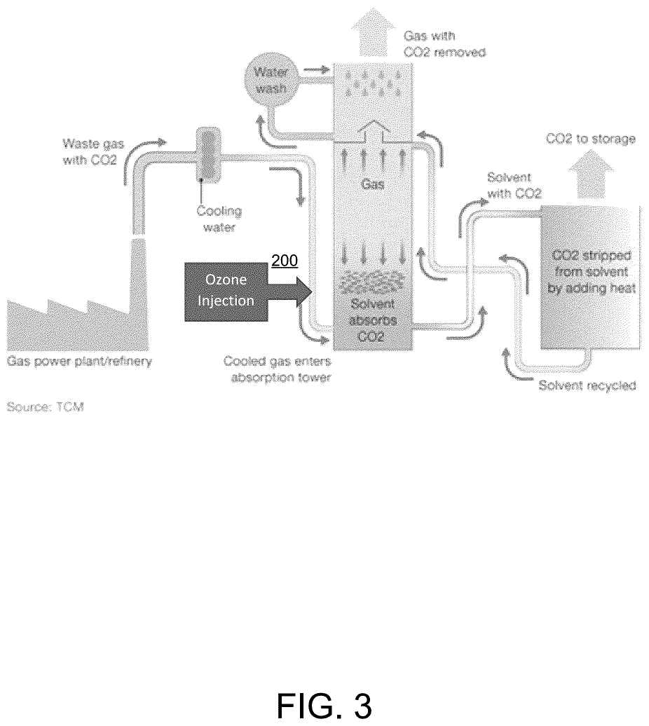

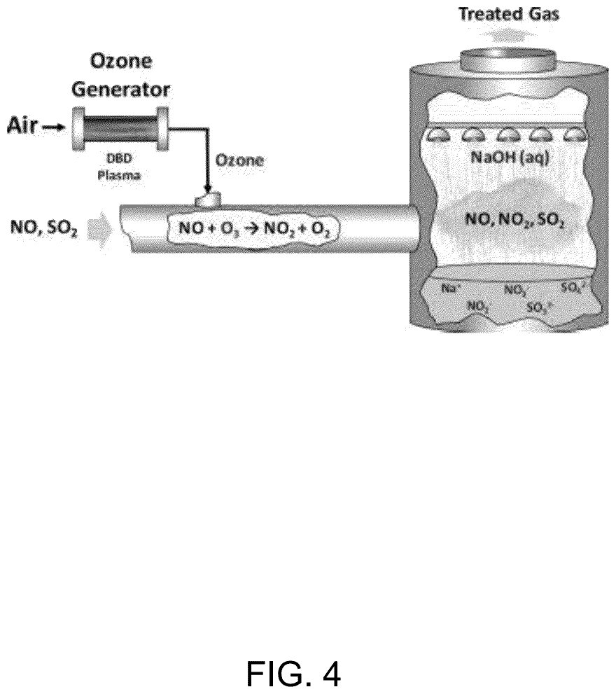

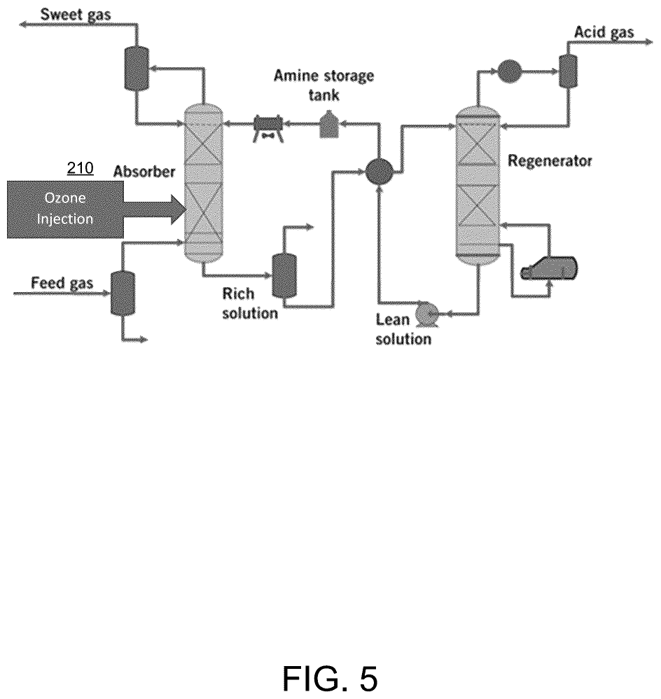

Ozone may also be a subsequent addition to an existing carbon capture system, as seen in FIGS. 3 and 4. Ozone is injected 200 into the cooled exhaust gas prior to entry into the scrubber/absorption tower. Ozone may also be used as a subsequent addition to a existing gas processing or treatment plant, as seen in FIG. 5. Ozone is injected 210 to the absorber to solubilize NOx to form a water soluble form, thereby reducing NOx by over 90%.

The present invention thus provides a more environmentally-friendly and efficient means of addressing several pollution and related concerns. First, the system eliminates open flaring by using the field gas in a field gas flare burner to heat produced water, and scrubbing the emissions using the heated produced water in a scrubbing unit. Second, the system eliminates or reduces the volume of produced water. Third, the system operates at or near the wellhead, thereby allowing use of the field gas while treating the produced water with less energy required. And fourth, carbon is captured for subsequent storage and/or sequestration.

Thus, it should be understood that the embodiments and examples described herein have been chosen and described in order to best illustrate the principles of the invention and its practical applications to thereby enable one of ordinary skill in the art to best utilize the invention in various embodiments and with various modifications as are suited for particular uses contemplated. Even though specific embodiments of this invention have been described, they are not to be taken as exhaustive. There are several variations that will be apparent to those skilled in the art.

What is claimed is:

1. A flare system for treating produced water, comprising:
a scrubber unit with a plurality of spray nozzles, said scrubber unit adapted to hold produced water;
a field gas flare burner adapted to heat the produced water in at least a portion of the scrubber unit;
a produced water pump adapted to circulate an amine solution to the spray nozzles, whereby sprayed amine solution as the scrubbing agent in the scrubber unit, wherein the amine is configured is configured to absorb CO₂; and
an amine tank adapted to receive the amine solution with absorbed CO₂.

2. The flare system of claim 1, whereby produced water is evaporated during processing in the scrubber unit.

3. The flare system of claim 2, further comprising means for removing salts and solids remaining after evaporation of the produced water.

4. The flare system of claim 3, wherein said means for removing comprises an augur.

5. The flare system of claim 3, further comprising a treatment mixer.

6. The flare system of claim 5, wherein the treatment mixer is configured to chemically stabilize the salts and solids removed from the scrubbing unit.

7. A method for treating produced water using flare gas, comprising:
introducing produced water into a scrubber unit with a plurality of spray nozzles;
heating, using a field gas flare burner, the produced water in at least a portion of the scrubber unit;
circulating amine solution to the spray nozzles, whereby sprayed amine solution acts as the scrubbing agent in the scrubber unit and absorb CO₂;
removing amine solution with absorbed CO₂ to an amine tank; and
heating the amine solution with absorbed CO₂ to recover and collect the CO₂ in gas form.

8. The method of claim 7, further comprising the step of evaporating produced water during processing in the scrubber unit.

9. The method of claim 7, further comprising the step of removing salts and solids remaining after evaporation of the produced water.

10. The method of claim 9, wherein the step of removing comprises removing using an augur.

11. The method of claim 9, further comprising the step of stabilizing the salts and solids removed from the scrubbing unit.
